(19) United States
(12) Patent Application Publication
(10) Pub. No.: US 2010/0128615 A1
(43) Pub. Date: May 27, 2010

(54) METHOD AND APPARATUS FOR THE DISCRIMINATION AND STORAGE OF APPLICATION SPECIFIC NETWORK PROTOCOL DATA FROM GENERIC NETWORK PROTOCOL DATA

(75) Inventors: John Monk, Colorado Springs, CO (US); Dan Prescott, Colorado Springs, CO (US)

Correspondence Address: PATENTTM.US, P. O. BOX 82788, PORTLAND, OR, 97282-0788, US

(73) Assignee: FLUKE CORPORATION, Everett, WA (US)

(21) Appl. No.: 12/504,554

(22) Filed: Jul. 16, 2009

Related U.S. Application Data
(60) Provisional application No. 61/081,071, filed on Jul. 16, 2008.

(51) Int. Cl. H04L 12/26

(52) U.S. Cl. 370/252

(57) ABSTRACT

Discrimination of application specific network traffic from other from general or unclassified network traffic is provided. Users may specify particular applications or data strings to be monitored.

### CROSS-REFERENCE TO RELATED APPLICATIONS

This application claims priority of U.S. provisional patent application 61/081,071, filed Jul. 16, 2008, entitled METHOD AND APPARATUS FOR THE DISCRIMINATION AND STORAGE OF APPLICATION SPECIFIC NETWORK PROTOCOL DATA FROM GENERIC NETWORK PROTOCOL DATA.

### BACKGROUND OF THE INVENTION

This invention relates to network test and measurement, and more particularly to an apparatus and method of discrimination of application specific network traffic from other general or unclassified network traffic.

In operation and maintenance of networks, determination of where issues or problem points arise can be complex. A network engineer or technician looking to resolve problems would be interested in having accurate network protocol statistics for specific applications of interest when monitoring a heterogeneous network environment.

### SUMMARY OF THE INVENTION

In accordance with the invention, the discrimination of application specific network traffic from other from general or unclassified network traffic is enabled. This invention solves the problem of being able to generate accurate network protocol statistics for specific applications of interest when probing a heterogeneous network environment.

Accordingly, it is an object of the present invention to provide an improved method and apparatus for network test and measurement.

It is a further object of the present invention to provide an improved method and apparatus for discriminating application specific protocol data from generic protocol data in a network environment.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a block diagram of a network with a test instrument installed thereon;

FIG. 2 is a block diagram of a test instrument;

FIG. 3 is a flow diagram illustrating operation of the invention in a URL (HTTP) case;

FIG. 4 is a flow diagram illustrating operation of the invention in a database names case;

FIG. 5 is a flow diagram illustrating operation of the invention in a Citrix PA names case; and

FIG. 6 is a flow diagram illustrating operation of the invention in an arbitrary patterns case.

### DETAILED DESCRIPTION

The system according to a preferred embodiment of the present invention comprises in a network test environment and keeps track of arbitrary network flows and the associated transactions within the flows. In doing this for the general case, various measurements about the general nature of the network traffic can be made.

In part of this processing, the invention examines the individual network packets for specific markers, which may be specified by the user and correspond to URLs, Database Names, Citrix PA names, or other arbitrary patterns. These markers are used to discriminate user defined applications. When packets with these markers are identified, those packets can be accounted for within the context of the user specified application, and hence, measurements for those applications can be made.

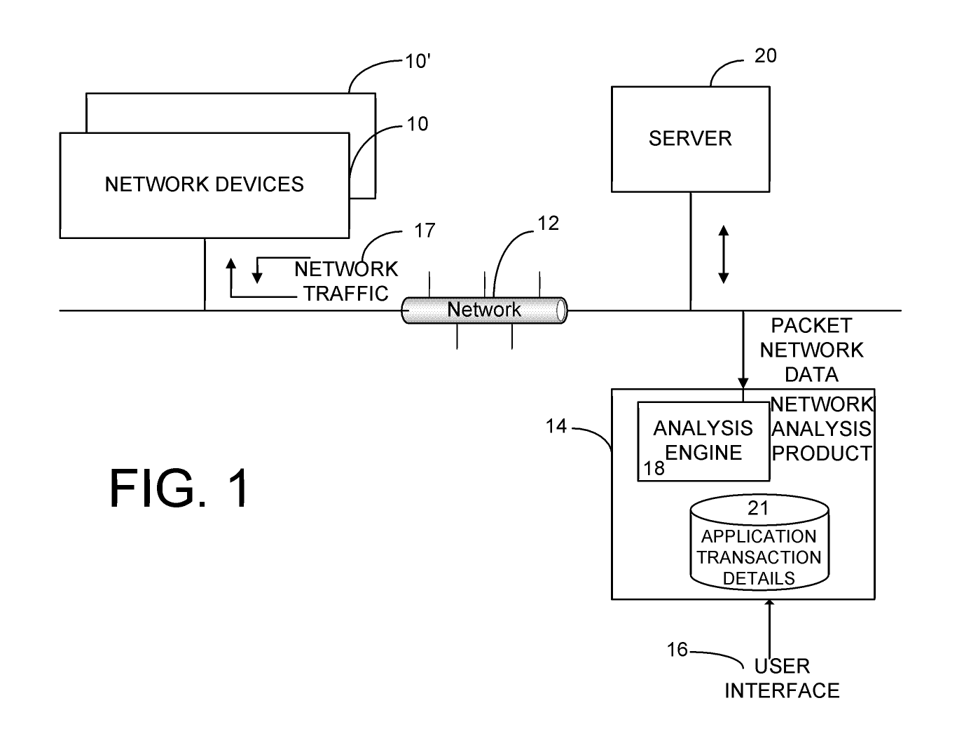

Referring to FIG. 1, a block diagram of a network with an apparatus in accordance with the disclosure herein, a network may comprise plural network devices 10, 10′, etc., which communicate over a network 12 by sending and receiving network traffic 17. The traffic may be sent in packet form, with varying protocols and formatting thereof.

A network analysis product 14 is also connected to the network, and may include a user interface 16 that enables a user to interact with the network analysis product to operate the analysis product and obtain data therefrom, whether at the location of installation or remotely from the physical location of the analysis product network attachment.

The network analysis product comprises hardware and software, CPU, memory, interfaces and the like to operate to connect to and monitor traffic on the network, as well as performing various testing and measurement operations, transmitting and receiving data and the like. When remote, the network analysis product typically is operated by running on a computer or workstation interfaced with the network.

The analysis product comprises an analysis engine 18 which receives the packet network data and interfaces with application transaction details data store 21.

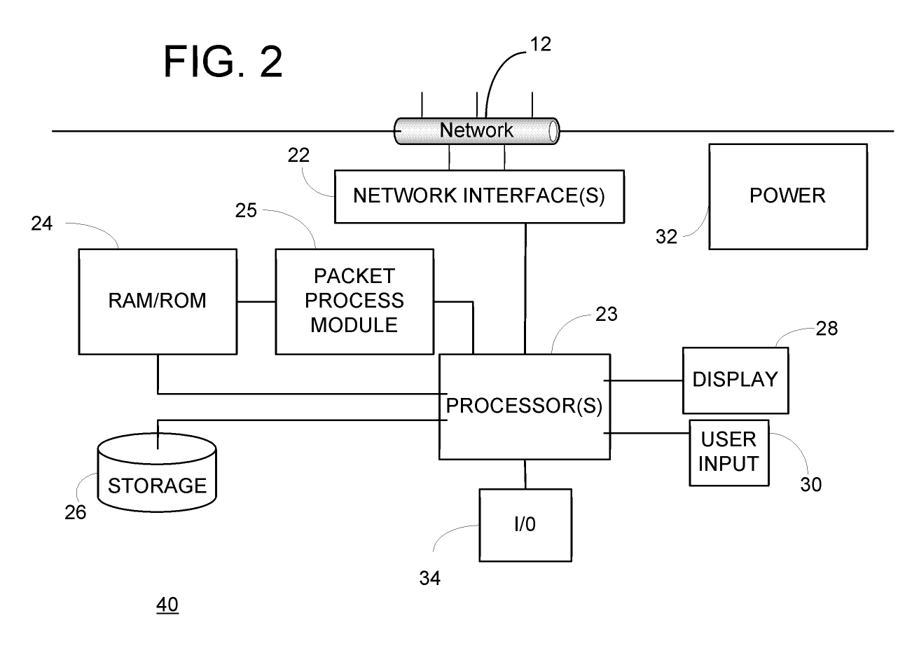

FIG. 2 is a block diagram of a test instrument/analyzer 40 via which the invention can be implemented, wherein the instrument may include network interfaces 22 which attach the device to a network 12 via multiple ports, one or more processors 23 for operating the instrument, memory such as RAM/ROM 24 or persistent storage 26, display 28, user input devices 30 (such as, for example, keyboard, mouse or other pointing devices, touch screen, etc.), power supply 32 which may include battery or AC power supplies, other interface 34 which attaches the device to a network or other external devices (storage, other computer, etc.). Packet processing module 25 provides processing of packets and storage of data related thereto for use in the analysis product to assist in the discrimination of and storage of application specific network protocol data from generic network protocol data, as discussed further herein.

In operation, the network test instrument is attached to the network, and observes transmissions on the network to collect information.

The packet process module 25 may suitably implement the analysis engine to monitor the network traffic, identify client and server conversations, and then reassemble the request and response packets between each client and server in order to analyze the transaction. The engine measures and records several usage and performance metrics for each transaction. Usage metrics include, among others, the number of bytes and the number of packets in the request and the response portions of the transaction. Performance metrics include the application response time which is the elapsed time required by the server to process the request and issue a response. The engine also records the request and response data from the transaction. An example of this information is the requested URL in a web transaction and the corresponding web page returned by the server.

Because applications use a variety of protocols and interact in a variety of ways, the engine performs application-specific analysis. The engine has application-specific analysis modules that perform analysis that is appropriate for the application being analyzed. For example, a web application is analyzed by the HTTP analyzer, and an Oracle database application is analyzed by the Oracle database analyzer.

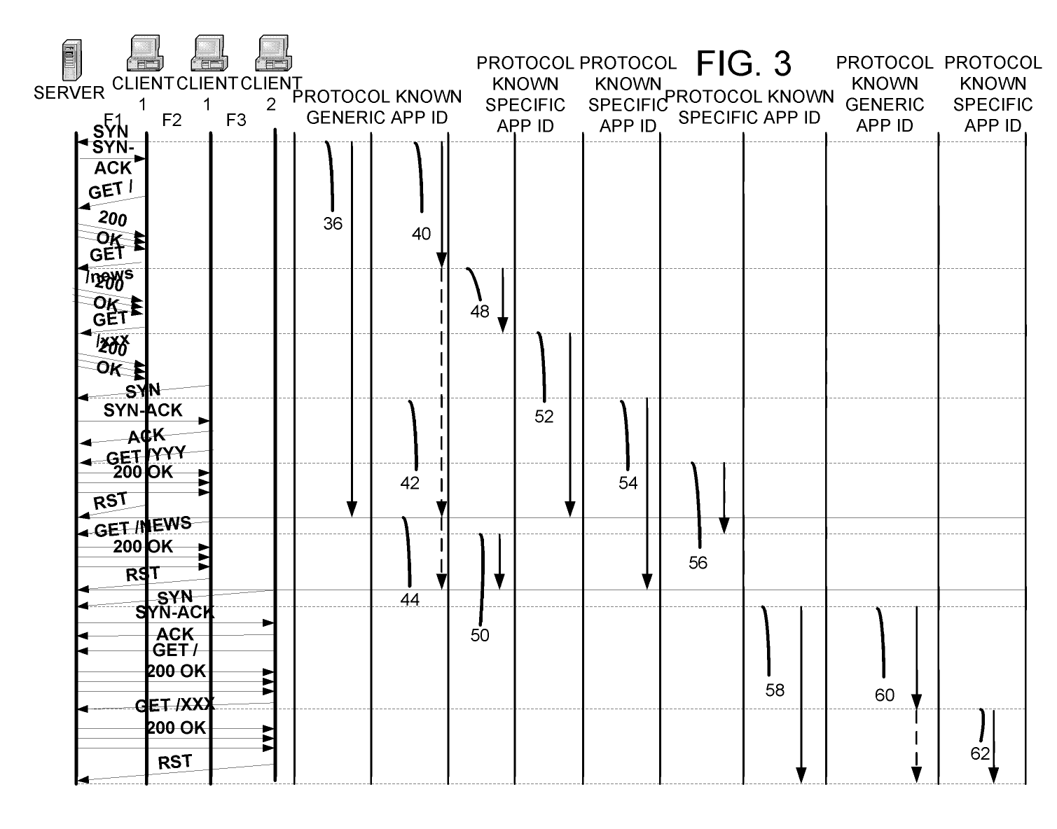

FIGS. 3-6 are diagrams illustrating particular examples of operation of analysis modules in the case of URLs (HTTP), database names, Citrix PA names, or arbitrary data string patterns.

FIG. 3 is a diagram showing timing and interaction in the case of URL (HTTP analyzer) discrimination. In the illustrated example network, a server and two clients, Client 1 and Client 2, are shown, as are three flows, F1, F2 and F3. The column below the titles F1, F2 and F3 show the exchanges between the server and clients, while the subsequent columns show the operation of collecting the various metrics/statistics in timing with the various data exchanges between server and clients. Statistics are compiled for generic applications and specific applications, with the statistics for generic applications being based on stack overhead packets and on any data packets that are not classified as part of a user defined application.

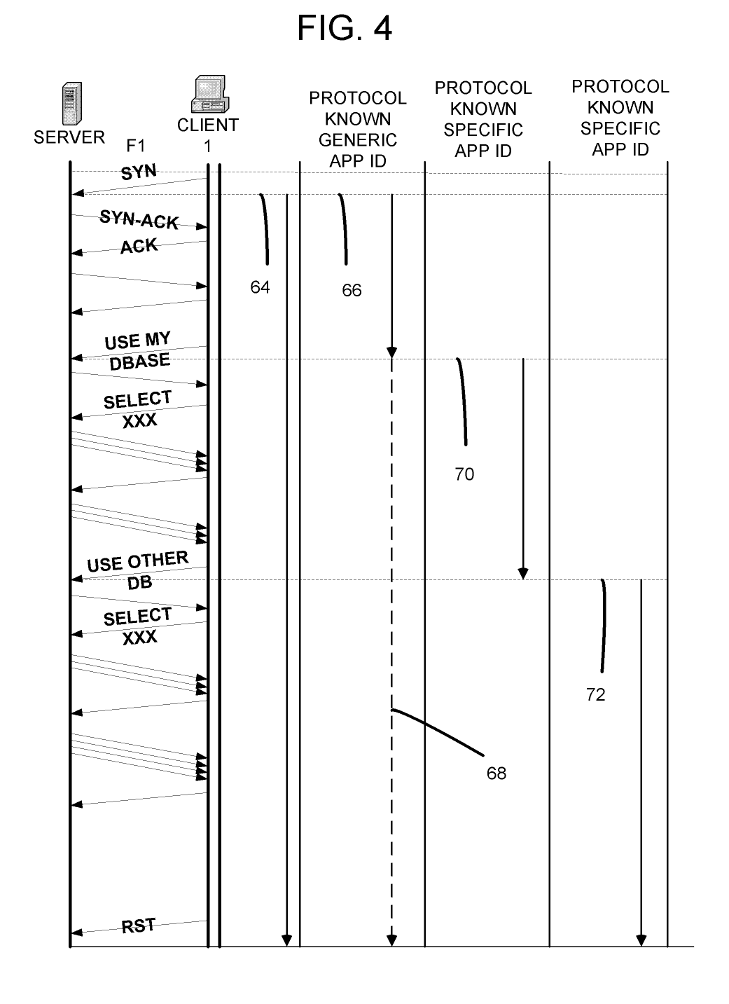

FIG. 4 is a diagram showing timing and interaction in the case of database access traffic via a database analyzer.

Initially once flow Fl is established between Server and Client 1, metrics and statistics are accumulated under the generic application ID mysql (for example). Once client 1 sends a USE command specifying a particular database, my_dbase in the example, then conversation statistics can be accumulated for that specific application ID of my_dbase. Later, when a USE other database (other db) command occurs from the client to server, a second set of conversation statistics may be established for the specific ID of other_db, and statistics are accumulated. While the specific application ID statistics are being accumulated, statistics for the generic application ID are accumulated based on stack overhead and based on any data packets not classified as part of user defined application. The operation continues until the rst command from the client to the server ends the flow Fl.

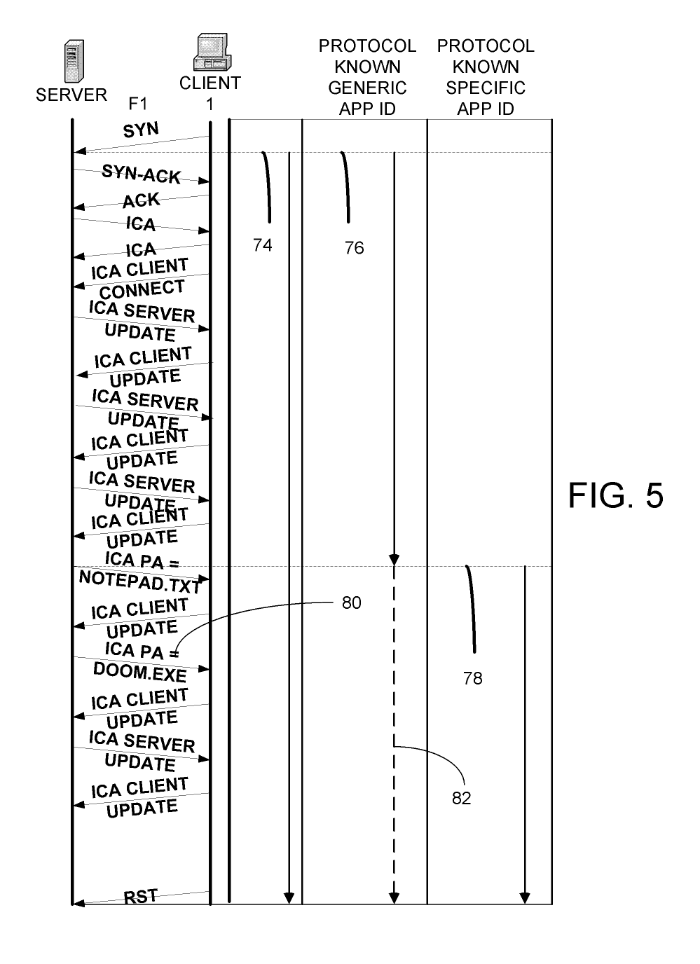

FIG. 5 is a diagram of operation Citrix analyzer in a Citrix streaming environment with server and Client 1. The syn, syn-ack, ack exchange starts the flow Fl, and metrics and statistics are accumulated under a generic application ID until such time as a specific identifiable application appears, in this particular example, the notepad.exe request. At this point, statistics can be accumulated under the specific application ID, notepad.exe in this particular example.

Statistics for the generic application ID are continued after the specific ID is known, but are done based on stack overhead packets.

In the illustrated example, a later ICA PA is shown for “doom.exe”. However, it would not be possible to differentiate the notepad.exe traffic from the doom.exe traffic. Modification of the CITRIX protocol that would allow such distinguishing would enable collection of separate statistics for the notepad.exe and doom.exe processes.

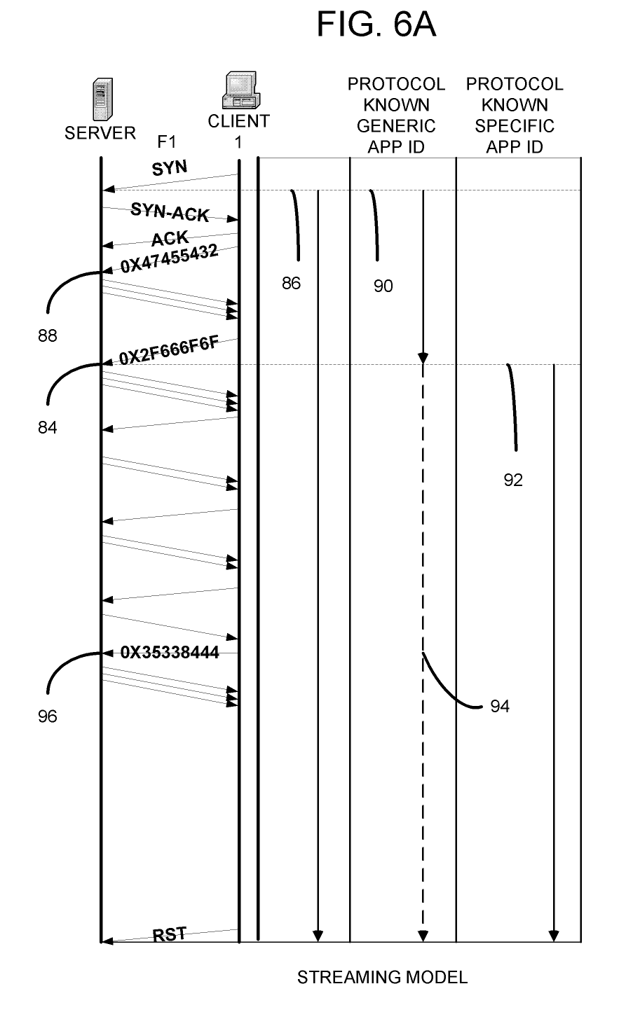

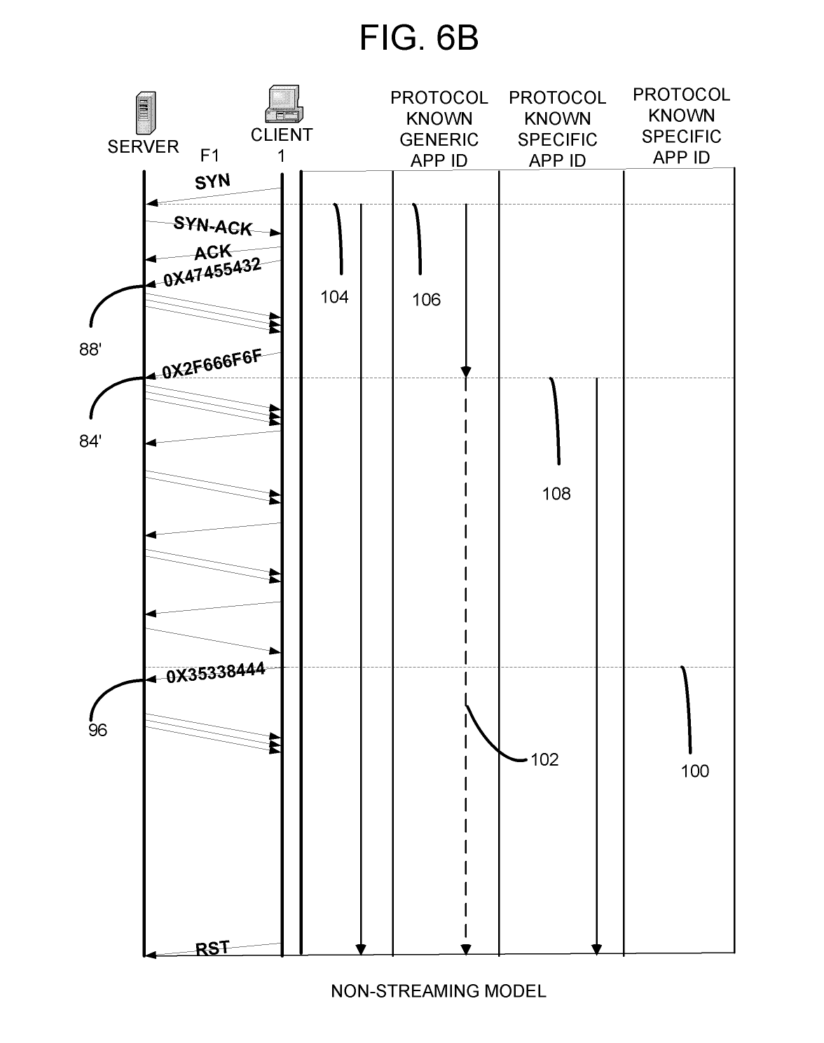

FIG. 6 is a diagram of operation in a streaming and non-streaming environment of a specific data string monitoring analyzer example. A user defined data string that may be related to network traffic monitoring the user is perform, may be specified. In the illustrated example, data string 0x2f666f6f has been specified of interest to monitor by the user. Once flow is established by the syn, syn-ack, ack exchange, generic ID statistics are accumulated. The data string 0x47455432 is not one that has been specified to be of interest in the example, so its appearance does not begin a specific protocol statistic accumulation. Once the string 0x2f666f6f does appear, however, conversation statistics are established for that data string, and statistics are accumulated for that data string.

In the case of a streaming model, a subsequent string 0x35338444 cannot enable differentiation from the string 0x2f666f6f, so statistics are continued to accumulate in the string 0x2f666f6f ID. However, in a non-streaming model, a subsequent string 0xx35338444 that was specified to be monitored, can result is conversation statistics being started and accumulated when that string appears.

Generic application statistics are accumulated based on stack overhead packets, after the specific application ID accumulation has begun

With the above, the user can define applications or data strings of interest for monitoring, and information is collected to provide metrics and statistics so network operation relative to the items of interest to the user can be obtained.

The metrics and statistics collection may be accomplished in accordance with the U.S. Provisional patent application 61080686 filed Jul. 15, 2008, entitled METHOD AND APPARATUS OF COMBINING MULTIPLE PACKETS INTO PROTOCOL TRANSACTIONS WITH REQUEST AND RESPONSE DETAIL FOR ENHANCED TROUBLESHOOTING IN A LINE RATE NETWORK MONITORING DEVICE and U.S. patent application 12242455, filed Sep. 30, 2008, entitled METHOD AND APPARATUS OF COMBINING MULTIPLE PACKETS INTO PROTOCOL TRANSACTIONS WITH REQUEST AND RESPONSE DETAIL FOR ENHANCED TROUBLESHOOTING IN A LINE RATE NETWORK MONITORING DEVICE.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A method for the discrimination and storage of application specific network protocol data from generic network protocol data, comprising:
examining individual network packets for specific markers; and
when packets with these markers are identified, accounting for those packets within a context of the user specified application, and hence, measurements for those applications can be made.

2. The method according to claim 1, wherein said specific markers may be specified by a user.

3. The method according to claim 1 wherein said markers correspond to URLs.

4. The method according to claim 1 wherein said markers correspond to, Database Names.

5. The method according to claim 1 wherein said markers correspond to Citrix PA names.

6. The method according to claim 1 wherein said markers correspond to arbitrary patterns.

7. An apparatus for discriminating and storing of application specific network protocol data from generic network protocol data, comprising:
a packet processing module examining individual network packets for specific markers and when packets with these markers are identified, accounting for those packets within a context of the user specified application, and hence, measurements for those applications can be made; and
storage for storing measurements by said packet processing module.

8. The apparatus according to claim 7, wherein said specific markers may be specified by a user.

9. The apparatus according to claim 7, wherein said markers correspond to URLs.

10. The apparatus according to claim 7, wherein said markers correspond to, Database Names.

11. The apparatus according to claim 7, wherein said markers correspond to Citrix PA names.

12. The apparatus according to claim 7, wherein said markers correspond to arbitrary patterns.
